(19) United States
(12) Patent Application Publication
(10) Pub. No.: US 2018/0374162 A1
(43) Pub. Date: Dec. 27, 2018

(54) Convenience Store Sales Tax Calculator and Method of Use

(71) Applicant: Dan Martinez, Sugar Land, TX (US)

(72) Inventor: Dan Martinez, Sugar Land, TX (US)

(21) Appl. No.: 16/047,118

(22) Filed: Jul. 27, 2018

Related U.S. Application Data
(63) Continuation-in-part of application No. 15/152,353, filed on May 11, 2016, now abandoned.

(51) Int. Cl. G06Q 40/00; G06F 17/30; G06F 8/30; H04L 9/32

(52) U.S. Cl. CPC G06Q 40/123; H04L 9/3213; G06F 8/31; G06F 17/30404

(57) ABSTRACT

A web based system that allows those responsible for paying convenience store sales and use taxes to easily submit their sales and expenses online and obtain a calculation of sales tax payable.

### CROSS-REFERENCE TO RELATED APPLICATIONS

This patent application is a Continuation-in-Part of U.S. patent application Ser. No. 15/152,353 filed on May 11, 2016 and incorporates all content and priority of said application as if set forth in full herein.

### STATEMENT REGARDING FEDERALLY SPONSORED RESEARCH

Not applicable.

### BACKGROUND

The present invention relates to systems and methods for calculating sales tax for businesses. In particular, aspects of the present invention relates to a web application for computation of sales tax.

The present invention is distinguished from the following prior art:

| U.S. Pat. | U.S. Pat. | U.S. Pat. | U.S. Pat. |
|---|---|---|---|
| No. 6,993,502 | No. 5,875,433 | No. 6,016,479 | No. 7,344,070 |
| U.S. Pat. | U.S. Pat. | U.S. Pat. | U.S. Pat. |
| No. 7,676,789 | No. 8,370,186 | No. 8,706,580 | No. 9,171,300 |
| US | US 2003/0097317 | US 2003/0144930 | US 2003/0144931 |
| 2002/0138282 | | | |
| US | US 2005/0228729 | US 2007/0185791 | US 2014/0089138 |
| 2005/0216351 | | | |
| US | US 2014/0304096 | US 2015/0088709 | US 2016/0019657 |
| 2014/0108213 | | | |

US 2017/0330286

Many states have enacted legislation to allow an increase in a state's Comptroller's ability to audit retailers. In Texas, for example, HB 11 was passed during the 80th Legislative Session in 2007. This specific piece of legislation dramatically increased the Comptroller's ability to identify, audit, and when appropriate, prosecute retailers who are collecting sales tax but not remitting the proper amount to the state. Many states have or are in the process of enacting similar legislation.

Generally, the HB 11 modifications amended the Texas Alcoholic Beverage Code and the Texas Tax Code to require distributors and wholesalers who make sales of ale, beer, wine, cigarettes, cigars and tobacco products to Texas retailers to report those sales monthly to the Comptroller's office. Those distributors and wholesalers are also required now to report that data electronically, unless an inability to do so is shown. Hence, there were modifications to reporting and taxation requirements.

As has occurred in Texas, HB 11 data, which has now been collected since January 2008, allows the Comptroller to compare the purchases that retailers have made of these products with the sales that retailers are required to report. Because both sets of data are largely received electronically, discrepancies can be more easily and rapidly identified. Rapid identification is essential so that the Comptroller auditors can begin their work to mitigate and recoup the revenue loss to the state due to any misreporting. Since fiscal year 2009, the Comptroller's office of Texas alone has identified more than $523 million due to the state that has been unpaid.

In some cases of tax avoidance, audit documentation may suggest that the taxpayer had criminal intent to evade taxes. If so, those cases could be reviewed and evaluated by the criminal investigations divisions of the governing authorities for the possible filing of criminal charges.

In some instances, if a retailer in Texas, like a convenience store, fails to maintain adequate records, the auditor could estimate sales and use taxes payable based on the purchase data collected from the convenience store's retailers under HB 11. That is, the auditor would estimate a markup on such purchase data and then estimate sales tax due based upon such marked up values. Use of these estimates could lead to higher audit assessments at the expense of the convenience store.

It has been found that one way to protect convenience stores from increased sales taxes is to eliminate the use of estimates, which can only be accomplished by keeping good records. To assist in recordkeeping and estimation of sales tax payable, several embodiments of the present invention have been developed to achieve such a goal.

### SUMMARY

In several embodiments, the present invention is a web based software application that allows those responsible for paying convenience store sales and use taxes to easily submit their sales and expenses online and obtain a calculation of sales tax payable through use of the novel and inventive system.

The present invention relates to a system for handling and automating the calculation of sales and use tax payable by convenience stores. In several embodiments, the application is web based and may be accessed by convenience store taxpayers on their own hardware via the internet. In several embodiments, convenience store taxpayers may register (and thereafter login) on a website. In these embodiments, the taxpayer can then then enter profile information (i.e. taxpayer ID, Name, Email Address), add store(s), enter purchase detail, sales markup percentage, and sales price into the application. In some embodiments, the taxpayer may also upload invoices relating to the transactions, and such invoices will be stored for the statute of limitations period relevant to maintaining tax records in order to assist a taxpayer with its recordkeeping and in the event of an audit.

In some embodiments, the system connects to a database that can use a SQL Server and taxability is determined based upon the database. In this embodiment, the database consists of product categories (i.e. Auto products, Bank Charges, Building Security, etc.) and within each product category is a list of products (i.e. Auto products category includes gasoline, inspection, maintenance, etc.). Taxability on said products can then be assigned at a product category level through use of the inventive system.

In some embodiments, the integral component of the system is a repository of products and expenses that are taxable and non-taxable. This repository is consumed by the logic used to produce the tax reports as can be generated by the end result of this system. Therefore, the ease of maintaining products, expenses, and their taxability is critical to the success of complete, accurate and efficient tax reporting as is produced by the present inventive system.

In some embodiments of the present invention, in the event a product input by the taxpayer is not identified by the database, the inventive application sends an email to the administrator. The administrator can review the product, determine taxability and update the database accordingly.

In several embodiments of the present invention, the present invention is a web-based taxation system comprising: a database; tax professional client data imported into said database from a user; said client data is transformed to support program taxability analysis; said transformed client data is assessed as taxable, non-taxable, or not-applicable and taxability rules are created and applied to client data as an indicator; said indicator is saved on said database and can be re-used to assess same or related future transformed client data; said indicator is reported to the client. In several embodiments, the web-based taxation system further comprises: automated sampling of said indicators is reviewed for accuracy of the taxability assignments; and said indicators are prepared for analysis and client presentation. In several embodiments, the web-based taxation system further contains the database which comprises product categories. In several embodiments, said database is administered externally from said client.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1 is a schematic of the administration requirements for one embodiment of the present invention.

FIGS. 2a-c are schematics for several embodiments for client management in the present invention.

FIG. 3 is schematics for several embodiments for administrative views in the present invention.

FIG. 4 is schematics for several embodiments for subscription and payment form boxes in the present invention.

FIG. 5 is a schematic for several embodiments for pending reports in the present invention.

FIGS. 6a-b are schematics for several embodiments for managing products in the present invention.

FIGS. 7a-b are schematics for several embodiments for client home view in the present invention.

FIG. 8 is a schematic of an embodiment of a client profile in the present invention.

### DETAILED DESCRIPTION

One or more illustrative embodiments incorporating the invention disclosed herein are presented below. Applicant has created a revolutionary and novel web based system that allows those responsible for paying convenience store sales and use taxes to easily submit their sales and expenses online and obtain a calculation of sales tax payable.

In the following description, certain details are set forth such as specific quantities, sizes, etc. so as to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Drawings are not necessarily to scale and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless, or essentially meaningless, the definition should be taken from Webster's Dictionary, New Edition, 2016. Definitions and/or interpretations should not be incorporated from other patent applications, patents, or publications, related or not, unless specifically stated in this specification or if the incorporation is necessary for maintaining validity.

Certain terms are used in the following description and claims to refer to particular system components. As one skilled in the art will appreciate, different persons may refer to a component by different names. This document does not intend to distinguish between components that differ in name but not function. The drawing figures are not necessarily to scale. Certain features of the invention may be shown exaggerated in scale or in somewhat schematic form, and some details of conventional elements may not be shown, all in the interest of clarity and conciseness.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

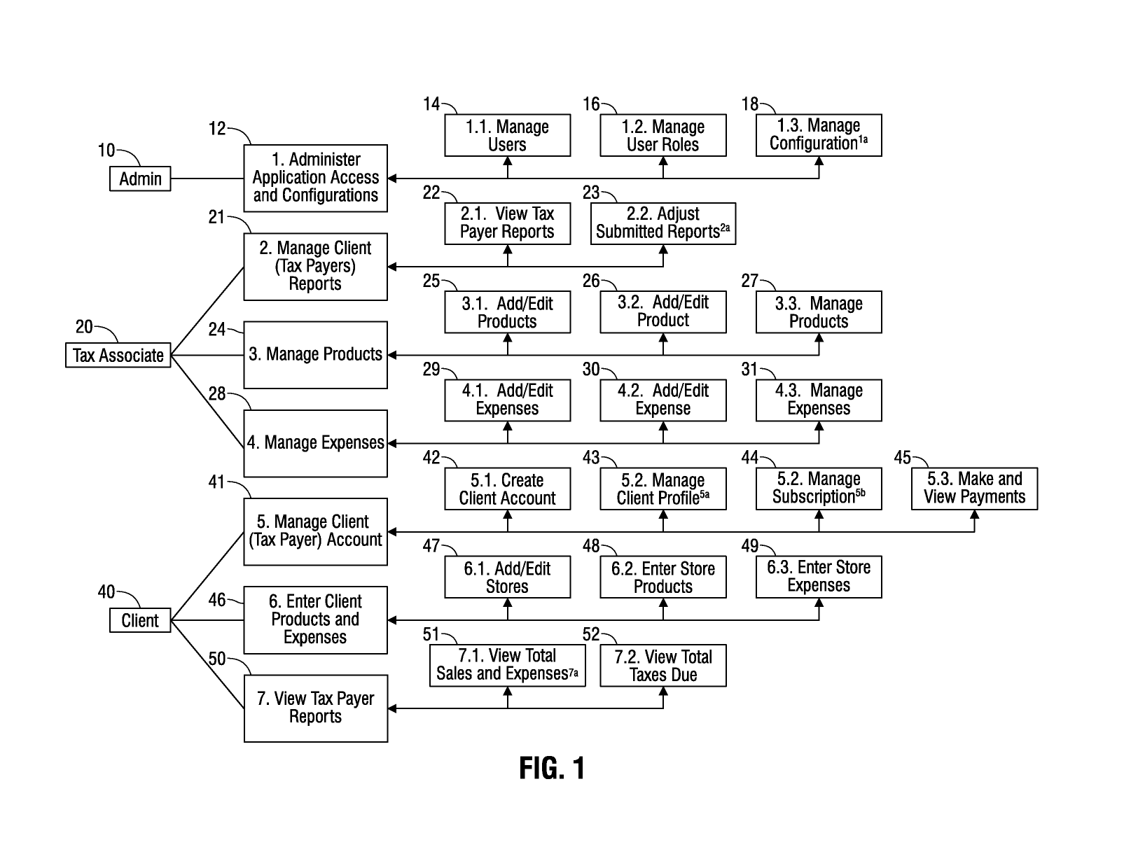

As shown, in several embodiments, FIG. 1 is a schematic of the administration requirements for one embodiment of the present invention. As shown in FIG. 1, in one embodiment of the present invention an administrator 10 can administrate the system 12 and manage users 14, manage user roles 16, and manage system configurations 18 in regards to taxability and tax implications.

In several embodiments of the invention, tax associate 20 can manage client reports 21 by viewing tax payer reports 22 and adjusting submitted reports 23. Tax associate 20 can also manage products 24 by adding/editing products 25 and 26 and can directly manage products 27 through taxable implications and taxability. Tax associate 20 can also manage expenses 28 by adding/editing expenses 29 and 30 and directly managing expense 31.

In several embodiments of the invention client 40 can manage their own client account 41 by creating a client account 42, managing a client profile 43, managing a subscription 44 and making and viewing payments 45. A client 40 can also enter client products and expenses 46 by adding/editing stores 47, entering store products 48 and entering store expenses 49. A client 40 can also view taxpayer reports 50 by viewing total sales and expenses 51 and viewing total taxes due 52.

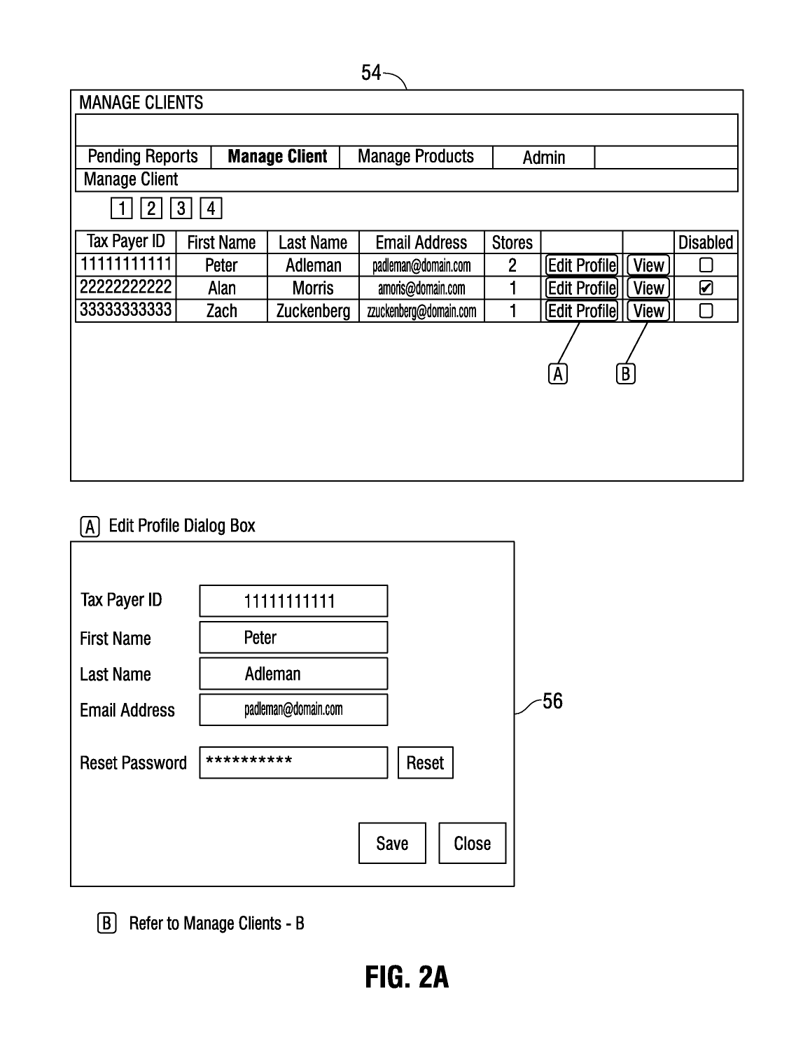

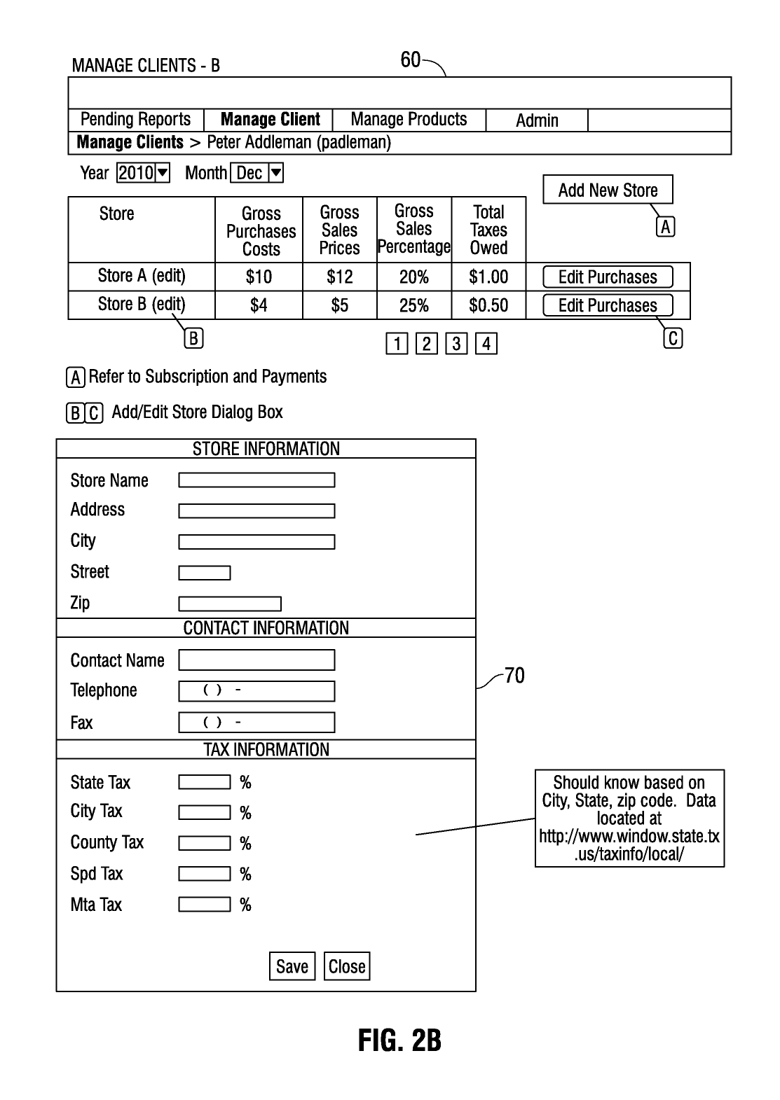

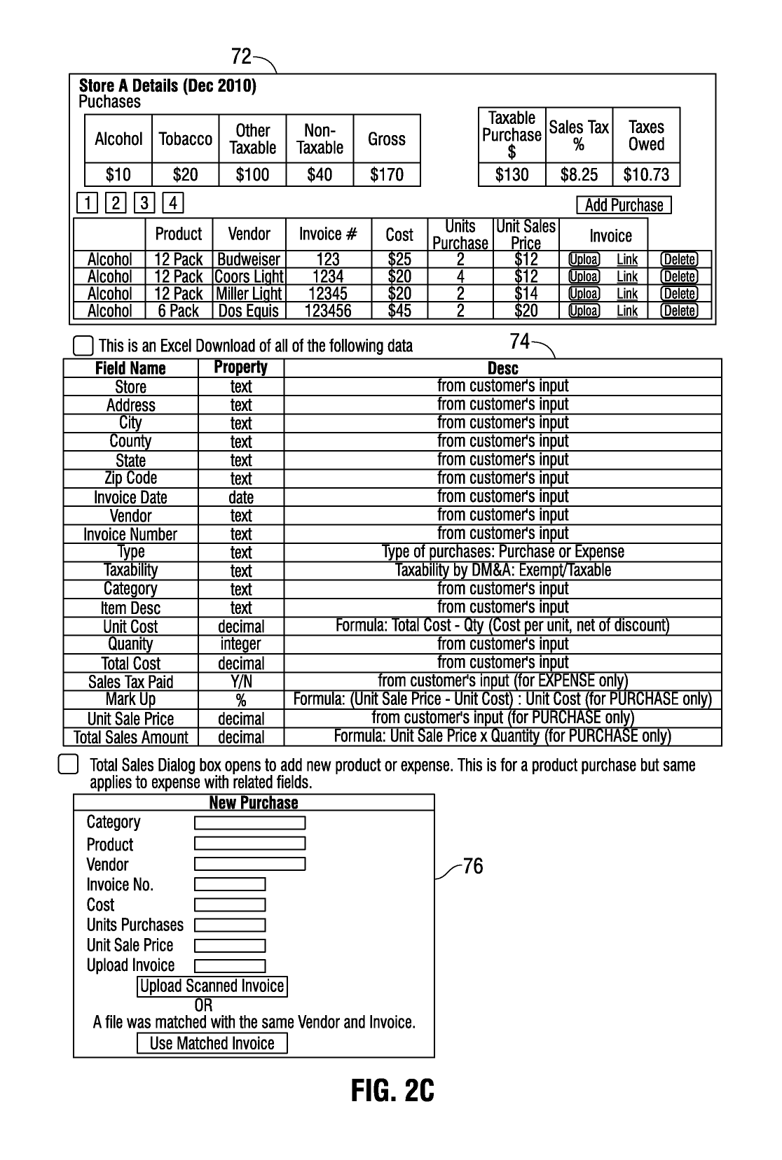

As shown, in several embodiments, FIGS. 2a-2c are schematics for several embodiments for client management in the present invention. As shown, various informational interfaces such as the Taxpayer ID chart 54, the edit profile dialog box 56, year sales box 60, store information input 70, store details box 72, data download box 74, and purchase information box 76 are all tools that can be utilized with the present invention in order for client 40, administrators 10 and tax associate 20 to manage the system through taxable implications and taxability.

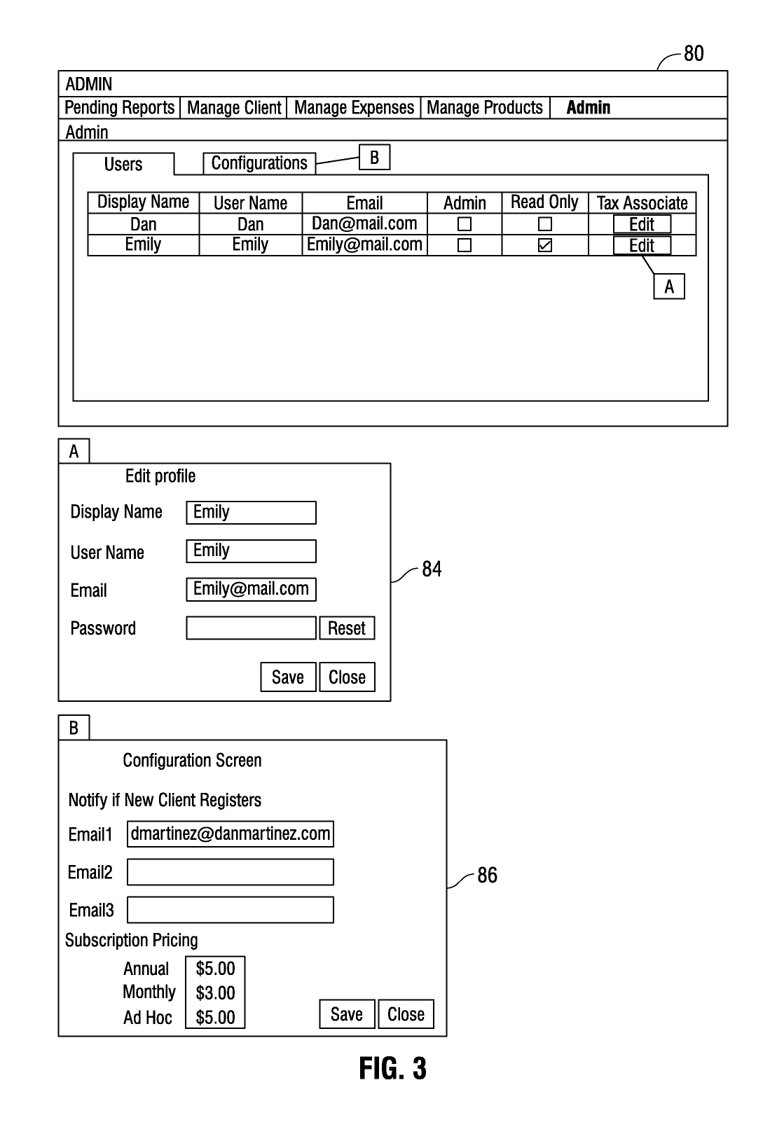

As shown, in several embodiments, FIG. 3 is schematics for several embodiments for administrative views in the present invention. As shown, are representative input screens for the general administration box 80, edit profile box 84, and configuration screens 86.

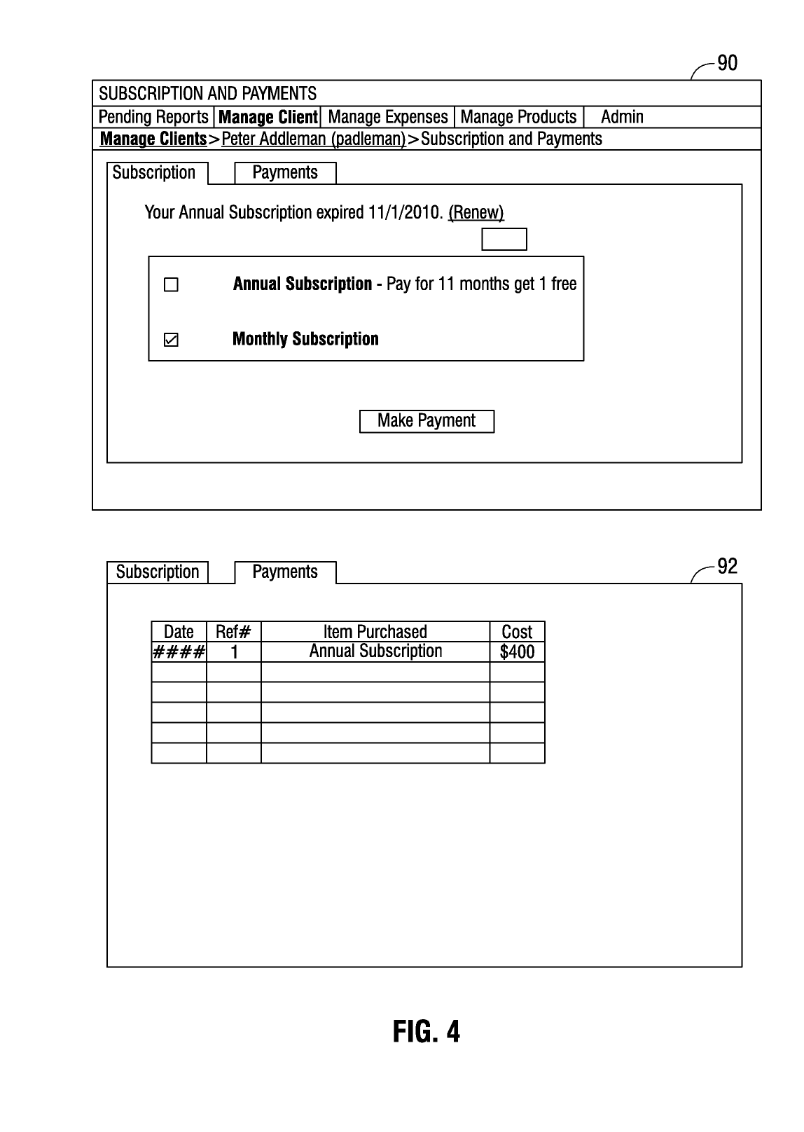

As shown, in several embodiments, FIG. 4 is schematics for several embodiments for subscription and payment form boxes in the present invention. As shown, are representative subscription and payment box 90 and payment box 92. FIG. 2A-4 are exemplary of several embodiments of the invention.

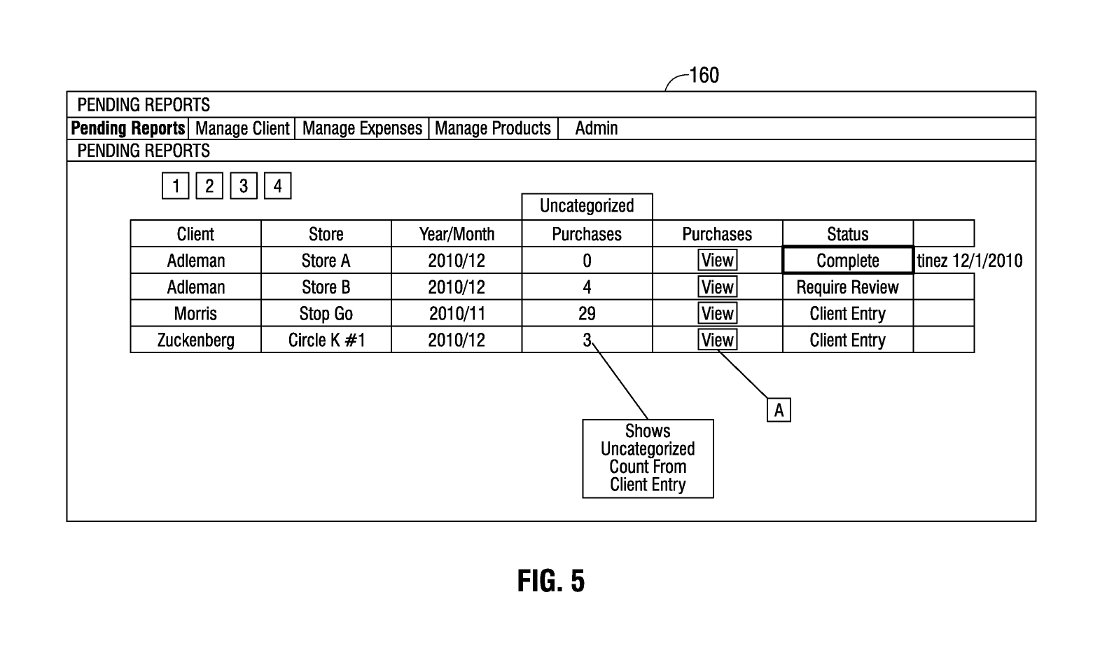

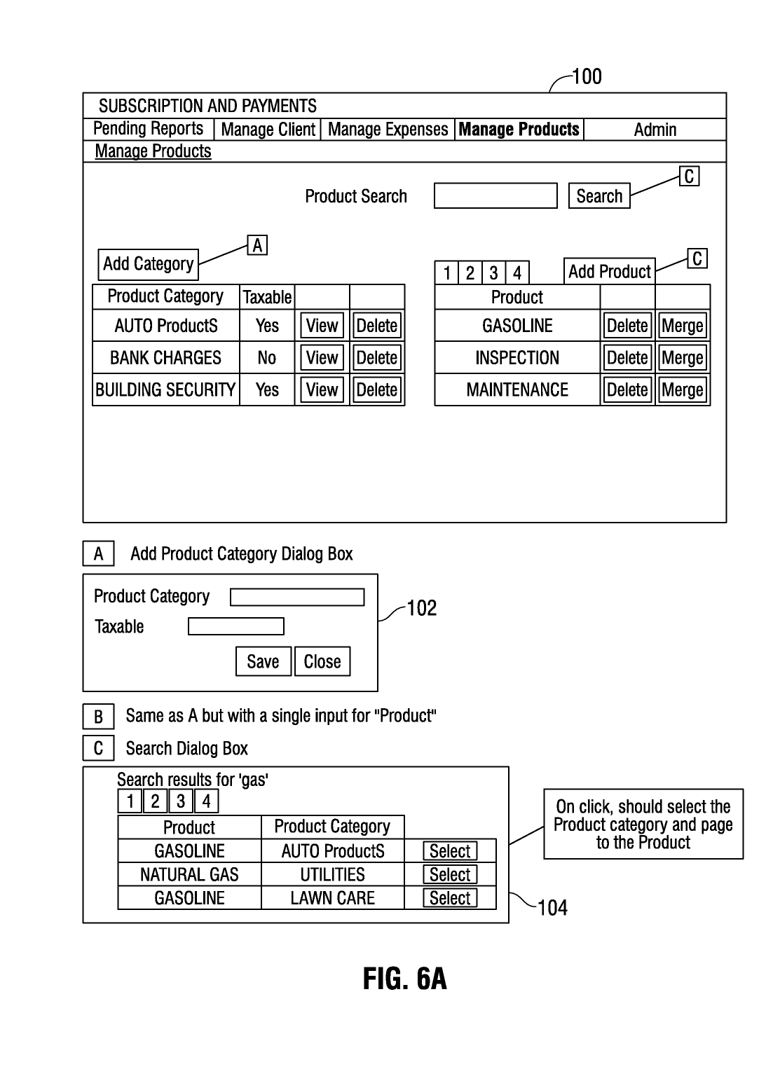

As shown, in several embodiments, FIG. 5 is a schematic for several embodiments for pending reports in the present invention. As shown, pending reports box 160 is representative of one embodiment of the present invention.

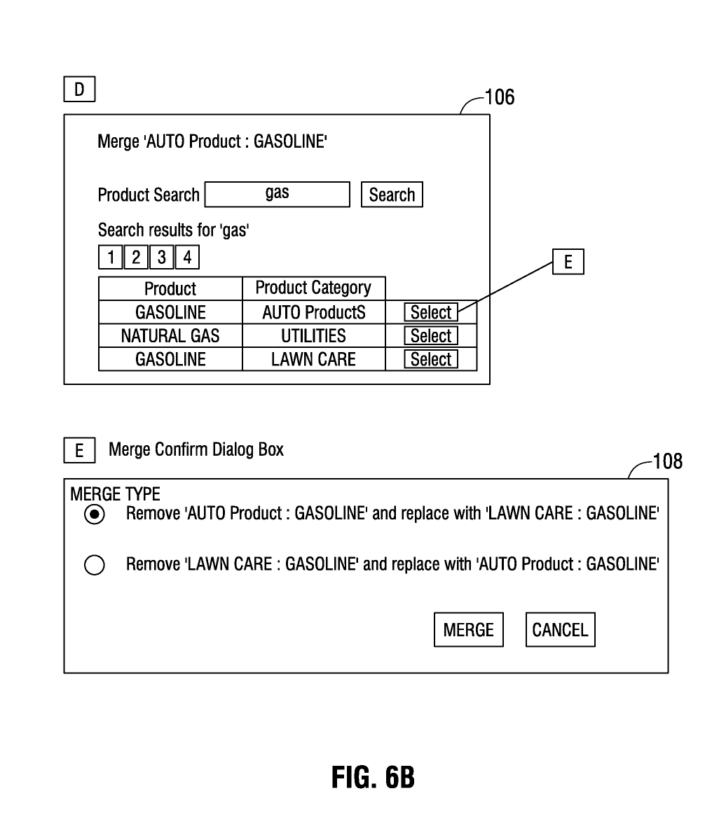

As shown, in several embodiments, FIGS. 6A-B are schematics for several embodiments for managing products in the present invention. As shown, in several embodiments of the present invention, products are managed through the manage products input box 100, add product category dialogue box 102, search results box 104, merge products box 106, and merge confirm dialogue box 108.

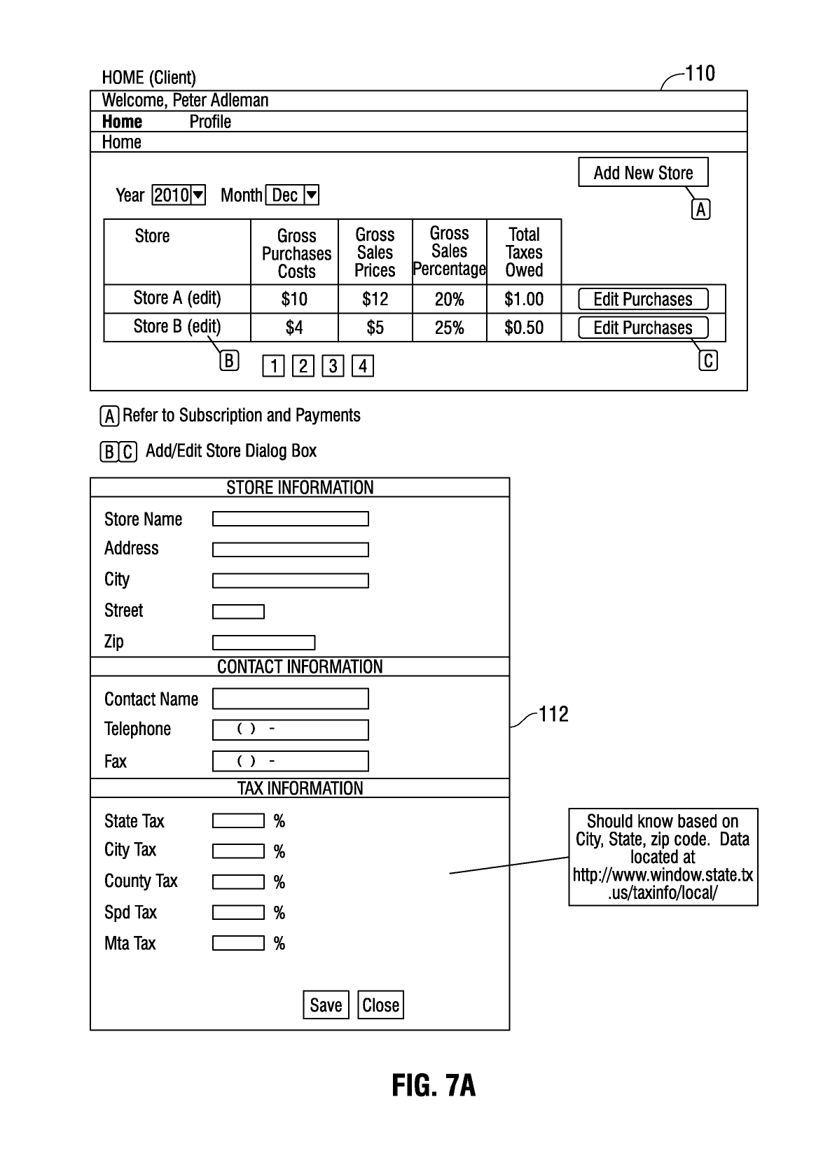

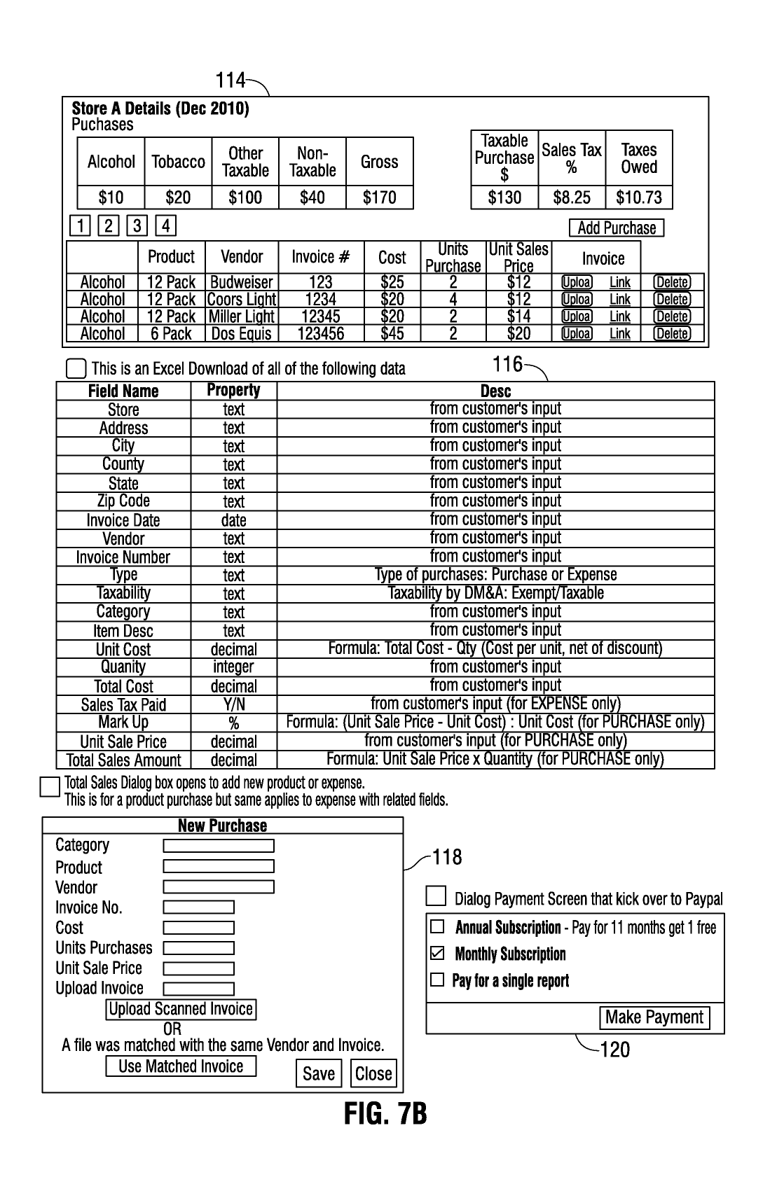

As shown, in several embodiments, FIGS. 7A-B are schematics for several embodiments for client home view in the present invention. As shown, is home input box 110, subscription store dialogue box 112, store details box 114, data input box 116, category input box 118, and subscription box 120.

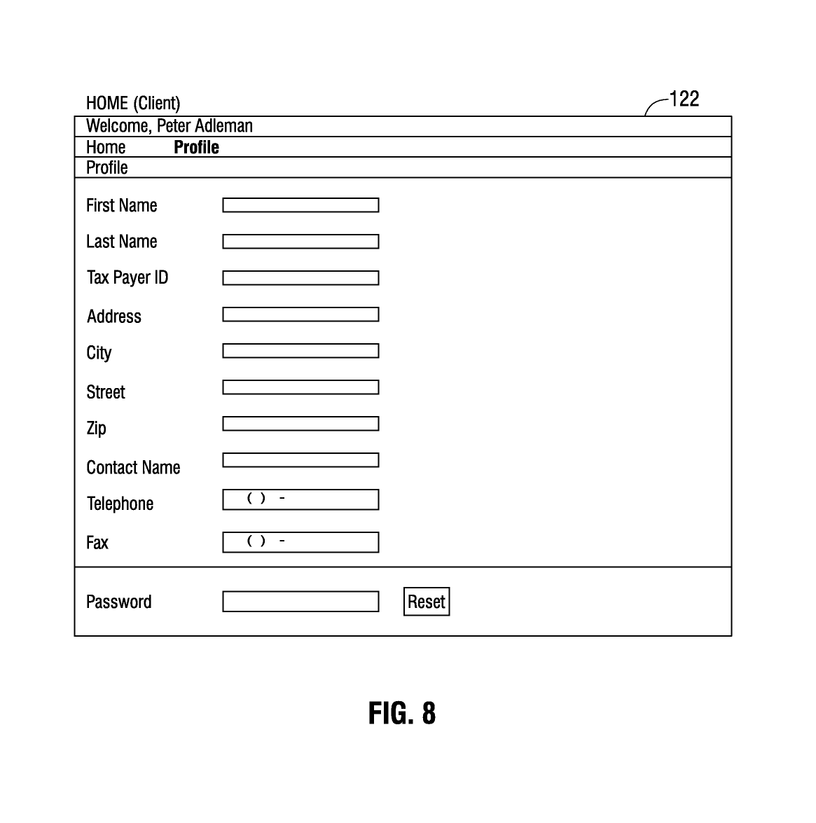

As shown, in several embodiments, FIG. 8 is a schematic of an embodiment of a client profile in the present invention. As shown, profile box 122 is exemplary of one profile of the present invention.

In several embodiments, the present invention involves a software for handling and automating the calculation of sales and use tax payable by convenience stores. The software application is web based and may be accessed by convenience store taxpayers on their own hardware via the internet. Convenience store taxpayers may register (and thereafter login) on a specified website. The taxpayer can then enter profile information (i.e. taxpayer ID, Name, Email Address), add store(s), enter purchase detail, sales markup percentage, and sales price into the application (FIG. 2). As also shown, the taxpayer may also upload invoices relating to the transactions, and such invoices will be stored for the statute of limitations period to assist taxpayer with its recordkeeping and in the event of an audit. The taxability of products is determined by the owner of the software. When items for purchase are entered by a user, pre-established codes are assigned to purchased items for taxability through the present inventive system for when a convenience store is buying a product. So at the end of purchase data entry, taxability is already assessed through a purchase method.

In several embodiments, the present system connects to the database using a SQL Server, and taxability is determined based upon the database once the goods are purchased by the convenience store. The database name can be “Convenience Store”. In several embodiments, the database consists of product categories (i.e. auto products, bank charges, building security, etc.), and within each product category is a list of products (i.e. Auto products category includes gasoline, inspection, maintenance, etc.). In several embodiments, taxability is assigned at a product category level, and a company may manage the products as illustrated in FIG. 4.

In several embodiments of the present invention, a component of the application is a repository of products and expenses that are taxable and non-taxable. This repository is consumed by the logic used to produce the tax reports. Therefore, the ease of maintaining products, expenses, and their taxability is critical to the success of complete, accurate and efficient tax reporting of goods purchased by the convenience store.

In several embodiments, in the event a product input by the taxpayer is not identified by the database, the application sends an email to the administrator. The administrator can review the product, determine taxability and update the database accordingly. To generate a report of taxability determinations, taxpayer need only checkout. “Checkout” is the time at which a user has finished entering the purchase and is ready to obtain his tax report.

In some embodiments of the present invention, the following is an overview of the application architecture.
A. Application Architecture
   a. The coding language is ASP.NET (C# .NET on .Net 4.0 Framework).
   b. Database: SQL Server 2005
   c. Database Server: Windows 2003
   d. Database Server Internal IP: 172.21.2.7 (Server Name: Server2650-new)
   e. Web Server: Windows 2008 (US 6)
   f. Web Server Internal IP: 172.21.2.8 (Server Name: web01)
   g. Web Server IP: 99.18.164.244
   h. Hosting Providers: n/a. However, PayPal is used for processing payments
B. Presentation.
   a. HTML: There is very limited HTML written in the application in the traditional manner. HTML is generated via one long string in the code behind file and then written to http context response. The application does use an ASP.Net master page named “convenienceStore.master”. Content holders on the master page are loaded with HTML within each of the .aspx files.
   b. CSSL: There is only one CSS file name “convenienceStore.css”. This file contains styling for every page combined. The CSS file is linked to all pages via the sole master page named “convenienceStore.master”. The CSS file is not minified.
   c. JavaScript: JavaScript is lightly used on the pages. The two primary uses are for input validation and AJAX calls for auto-completion of city, county, and sales tax. JavaScript is not externally referenced, is limited with Object Oriented Programming (OOP), and is not minified.
C. Business Logic
   a. JavaScript: Client side scripting is limited
   b. C#.NET: The coding technique is primarily procedural(i.e., there is limited use of OOP). The Data Access Layer (DAL) is tightly coupled and ADO.NET calls using the System.Data.SQLClient.SQLConnection class are on every page where database commands are required. Inline SQL is used for all database commands. There are no factory patterns, but there are some helper/utility classes regarding input checking, creating tabs, and generating navigation. Configurations (e.g., database connection string, email server, default tax rates, etc.) are stored in text files within the site directory. There are classes that read these configurations and provide the settings noted throughout the applications. For example, the sqlSource class opens the text file sqlSource.txt, gets the noted connection string listed in the text file, and provides the connection string for ADO.Net calls via the method getSqlSource( ) throughout the application. As for state maintenance, there is limited use of caching, but session state is used to store whether or not the user is an Admin. There appears to only be two roles/privileges, which are Admin or Client. Users login on the page, Login.aspx, where it is determined whether the user is an admin or client, and then stored in the session. The application uses impersonation and runs under the Domain Controller Admin account renamed “Master”.
D. Data Access Layer: ADO.NET is used to access the database. The site stores connection strings in the text files located in the database directory (which uses integrated security). The application connects to the database (convenienceStore) using the SQL Server sa account.
E. Data (SQL Server): Table entity relationships appear to be in 2nd Normal form in a SQL Server 2005 database. The database name is “convenienceStore”. There are no stored procedures, functions or triggers. There are several views created to retrieve data more efficiently.
F. Security
   a. Server: The server is not patched on a regular schedule. A Business Class DSL connection is used to connect to the web server. The web server and database server are running on the “danmartinez” domain and not running on a DMZ.
   b. Website: IIS runs under the IIS anonymous user and is configured to use Windows Integrated Authentication. The use of Windows Integrated Authentication is unknown. Accessing the regular site (i.e., presentation of content) runs under the account danmartinez/master via impersonation set within the web.config. There are only two roles/privileges, which are Client and Admin. If you are Admin, you can view everything, and if you are Client, then you can load sales, load expenses, and then view/purchase reports.
   c. Database: The application only has one database and the connection to the database from the application uses the SQL server sa account.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

I claim:

1. A web-based store purchasing taxation system comprising:
a database;
tax professional client data imported into said database from a user;
said client data is transformed to support program taxability analysis;
said transformed client data is assessed as taxable, non-taxable, or not-applicable and taxability rules are created and applied to client data as an indicator;
said indicator is saved on said database and can be re-used to assess same or related future transformed client data;
said indicator is reported to the client.

2. The web-based store purchasing taxation system of claim 1 further comprising:
automated sampling of said indicators is reviewed for accuracy of the taxability assignments; and said indicators are prepared for analysis and client presentation.

3. The web-based store purchasing taxation system of claim 1 further comprising:
said database comprises product categories.

4. The web-based store purchasing taxation system of claim 1 further comprising:
said database is administered externally from said client.

5. A store purchasing taxation accounting system comprising:
an application architecture;
said application architecture further comprising; coding language, a database, a database server, database server internal IP, a web server, a web server internal IP, a web Server IP, and hosting providers;
a presentation platform;
said presentation platform further comprising; HTML, CSSL, and JavaScript;
a business logic;
said business logic further comprising; said JavaScript, and C#.NET;
a data access layer;
data; and
a security platform;
said security platform further comprising; a server, website, and said database.

6. The store purchasing taxation accounting system of claim 5 further comprising:
said coding language is C# .NET on .Net 4.0 Framework.

7. The store purchasing taxation accounting system of claim 5 further comprising:
said HTML is generated via one long string in the code behind file and then written to http context response.

8. The store purchasing taxation accounting system of claim 5 further comprising:
said data access layer uses ADO.NET to access the database.

9. The store purchasing taxation accounting system of claim 5 further comprising:
the connection to said database from the application uses a SQL server sa account.

10. The store purchasing taxation accounting system of claim 5 further comprising:
said website utilizes an IIS that runs under the IIS anonymous user and is configured to use Windows Integrated Authentication.

11. The store purchasing taxation accounting system of claim 5 further comprising:
said data has no stored procedures, functions or triggers.

12. The store purchasing taxation accounting system of claim 8 further comprising:
said data access layer is tightly coupled and ADO.NET calls using the System.Data.SQLClient.SQLConnection class are on every page where database commands are required.

13. The store purchasing taxation accounting system of claim 12 further comprising:
Inline SQL is used for all of said database commands.
